(19) United States
(12) Patent Application Publication
(10) Pub. No.: US 2004/0026652 A1
(43) Pub. Date: Feb. 12, 2004

(54) Processes and compositions for treating fabric

(76) Inventors: Joseph Hummel, Perkasie, PA (US); George Bognar, Allentown, PA (US)

Correspondence Address: Watts Hoffman, Fisher & Heinke, Suite 1750, 1100 Superior Avenue, Cleveland, OH, 44114, US

(21) Appl. No.: 10/398,987

(22) PCT Filed: Oct. 11, 2001
(86) PCT No.: PCT/US01/31707

(30) Foreign Application Priority Data
Oct. 13, 2000 (US) 60240233

(51) Int. Cl. B05D 3/02; D06M 10/00

(52) U.S. Cl. 252/8.61; 427/385.5

(57) ABSTRACT

A composition and method for treating fabric to increase abrasion resistance and cut resistance of the fabric. The composition includes from 1 to 20% of a softener by weight, from 0.1 to 20% of a surfactant by weight and from 60 to 98.9% water by weight. In the method, a fabric is saturated with the fabric treatment mixture. Excess fabric treatment mixture is removed from the fabric. The fabric is dried to cure the fabric treatment mixture.

### FIELD OF THE INVENTION

The present invention relates generally to a processes and compositions for treating fabric and more particularly to a process and composition for increasing cut resistance and abrasion resistance of fabric.

### BACKGROUND OF THE INVENTION

There is a continuing need for fabrics that resist cuts and abrasions that occur when a sharp edge of a knife, a tool having a sharp edge or items having sharp edges are encountered. Such fabrics are particularly useful for making protective clothing, such as gloves, for use in activities such as meat cutting, handling of metal and glass articles that have rough edges and automotive applications.

Several approaches to making cut resistant fabrics have been contemplated by the prior art. For example, it has been found that certain kinds of fibers and yarns can be woven or knit into fabrics that are resistant to cutting. Cut resistant yarn may include a flexible metal wire or fiberglass core or may consist of highly oriented fibers having a high modulus and high tensile strength, such as aramids, thermotropic liquid crystalline polymers, and extended chain polyethylene.

Another approach to making cut resistant fabrics is disclosed in U.S. Pat. No. 4,555,813 to Johnson. The '813 patent discloses coating a surface of a fabric to create an abrasion resistant or cut resistant gripping surface of a glove. A fabric web comprised of a woven or non-woven web is coated with a foam surface that increases cut resistance of the article.

### SUMMARY OF THE INVENTION

The invention relates to a composition for treating fabric that is economical, easily applied, safe to use and can be used repeatedly. The inventive composition can be applied to the fabric by those methods known to those skilled in the art. Methods of application include, but are not limited to, application by dipping, spraying, or roller coating.

In general, the composition comprises:

a. softener in an amount ranging from 1 to 20 parts by weight;

b. surfactant or surface active agents in an amount ranging from 0.1 to 20 parts by weight.

c. water in an amount ranging from 60 to 99 parts by weight.

An acid may be optionally added. The amount of acid added is effective to maintain the pH of the solution in a range from about 4.0 to about 5.5. In the event that acid is added to adjust the pH to the aforementioned range, it is preferred to use acetic acid.

In one embodiment, the composition is a solution having a pH in a range from about 4.0 to about 5.5. The composition includes the following ingredients:

a. a silicone softener in an amount ranging from about 1 to about 10 parts by weight based upon the total weight of the composition, a preferred silicone softener being ULTRATEX commercially available from Ciba Giegy Corporation;

b. A first surfactant or surface active agent in an amount ranging from about 1 to about 10 parts by weight based upon the total weight of the composition, preferred first surfactants include fluoropolymers especially those sold under the trademark ZONYL by Ciba Geigy Corporation;

c. A second surfactant in an amount ranging from about 0.01 to about 2 parts by weight based upon the total weight of the composition, preferred second surfactant being selected from the group consisting of anionic, cationic, or non-ionic surfactant such as those sold by Fisher Scientific under the trade name ALKANOL; and

d. water in an amount ranging from about 78 to about 98 parts by weight based upon the total weight of the composition.

The sum of the weights of the composition preferably totals 100 parts by weight. Of course, other compounds (such as preservative, or other type of chemical softener such as polyethylene, fatty acids, etc.) may be added or omitted from a calculated formulation that has amounts of compounds that total 100 parts by weight, in which case the relative amounts of each of the compounds would be adjusted accordingly to total 100 parts by weight, as would be apparent to one skilled in the art in view of this disclosure.

In a preferred embodiment, a method of treating fabric comprises selecting a fabric and saturating the fabric with a solution of the inventive composition. Excess solution is removed from the fabric and the fabric is then exposed to a temperature for a time to effectively cure and dry the fabric. In one embodiment, the fabric is terry cloth. The solution of the composition preferably has a pH in a range from about 4.0 to about 5.5 The solution may be applied by techniques known to those skilled in the art.

In one embodiment, the solution is applied by a Tubex™ machine. The Tubex™ machine includes compression rollers in which the saturated fabric is fed for removing excess solution. The Tubex™ machine also insures that the solution penetrates and wets the fibers within the fabric. The solutions of the inventive compositions are reusable. The fabric after treatment exhibits increased abrasion and cut resistance.

The use of the treated fabric for knitting gloves result in a softer and more comfortable fitting glove. Furthermore, it has been found that gloves made from these yarn composites exhibit good durability and demonstrate improved gripping power over prior art gloves. Moreover, the treated fabric increases cut resistance and abrasion resistance. In another embodiment, the solution is applied using a washing machine. The solution is then dried in a dryer that raises the temperature of the fabric to approximately 300° F.

Other objects and a fuller understanding of the invention will be had from the following detailed description, considered in connection with the accompanying drawings.

### BRIEF DESCRIPTION OF THE DRAWINGS

FIG. 1 is an elevational view of a glove made of a fabric treated in accordance with the present invention; and,

FIG. 2 is a cross-sectional view of a strand of a fabric treated with a solution of the present invention.

### DETAILED DESCRIPTION OF THE PREFERRED EMBODIMENTS

The present invention is directed to an aqueous solution including a silicone softener for treating fabric, a method of treating fabric, and cut resistant gloves 10 that have a coating 12 formed by the aqueous solution on the fabric 14 of the glove. Application of the solution to fabric increases the abrasion resistance and cut resistance of the fabric. The treated fabric is especially suitable for use in the manufacture of apparel such as gloves.

The present invention is a composition of silicone softener and surfactant, also known as a surface active agent, in an aqueous solution for easy application to fabric using conventional means such as immersion, spraying, dipping, and the like. In addition, the composition can be applied with a commercial washing machine. In one embodiment, coating technology is used to build-in aspects such as reduced splatter or splashing during application, shelf life stability and improved surface wetting. The pH of the present invention is from about 4.0 to about 5.5. A pH in this range is only mildly acidic and as such is safe to use. Preferably, the pH of the solution is adjusted by the addition of acetic acid.

The composition of one embodiment of the present invention comprises silicone softener in an amount ranging from about 1 to about 20 parts by weight. In the exemplary embodiment, the silicone softener ranges from about 1 to about 10 parts by weight. In one embodiment, the composition includes a mixture of surfactants in an amount ranging from about 0.1 to about 20 parts by weight, and water in an amount ranging from about 60 to about 99 parts by weight. In the exemplary embodiment, the water ranges from about 78 to about 98 parts by weight. In the exemplary embodiment, the mixture of surfactants includes a first surfactant or surface active agent such as an fluoroalkyl polymer in an amount ranging from about 1 to about 10 parts by weight and a second surfactant such as a long chain fatty acid salt ranging from about 0.01 to about 2 parts.

The sum of the weights of the composition preferably totals 100 parts by weight. Of course, other compounds (such as preservative, or other type of chemical softener such as polyethylene, fatty acids, etc.) may be added to or omitted from a calculated formulation of the composition that has amounts of compounds that total 100 parts by weight, in which case the relative amounts of each of the compounds would be adjusted accordingly to total 100 parts by weight, as would be apparent to one skilled in the art in view of this disclosure.

Silicone softeners that may be used in accordance with the present invention are commercially available under the trade name ULTRATEX from the Ciba Geigy Corporation. The disclosed invention is not limited to this particular silicone softener. Other silicones softeners that may be used in accordance with the present invention include cationic reactive silicone softeners, anionic and non-ionic silicone softeners and the like. Moreover, the silicone softener may include additional chemical softeners such as polyethylene and fatty acid type softeners. The pH of the disclosed composition using silicone softeners is in a range from about 4.0 to about 5.5.

The silicone softeners provide the following advantages when applied to fabric:

a. improves wetting resistance;

b. increases abrasion resistance; and

c. increases cutting resistance.

The surfactants or surface active agents used in accordance with the present invention are stable in compositions having a pH in the range from about 4 to about 5.5. The surface leveling agents that are preferably used are long chain fluorinated compounds and salts. Examples of suitable commercial surface active agents include those sold under the trade names ZONYL commercially available from Ciba Geigy Corporation and FLUORAD commercially available from the 3M corporation. Other surface active agents for use in the present invention would be apparent to one skilled in the art in view of this disclosure.

The surfactants or surface active agents offer the following advantages when applied to fabric:

a. reducing the surface tension;

b. improving wettability; and

e. controlling viscosity and consistency.

The composition may also contain chemical additives. These additives can include, but are not limited to, other surfactant and wetting agents, preservatives and pH modifiers. Examples of surfactant and wetting agents are modified polyethers, modified alkylperoxy ethanols and ethoxylated acetylenic compounds such as those supplied by Air Products under the trade names SURFYNAL 485W, SURFYNAL 104DPM and those supplied by Union Carbide under the trade names TRITON X405 and TRITON CF10. Examples of suitable preservatives include 1(3-chloroallyl)-3,5,7-triaza-1-azoniaadamantane chloride available by Dow Chemicals under the trade name DOWICIL 75, and 2-(hydroxymethyl)amino-2-methylpropanol under the trade name TROYSAN 192. Examples of a suitable pH adjuster includes acetic acid. Other chemical additives for use in the composition would be apparent to one skilled in the art in view of this disclosure.

The chemical additives have the following functions:

a. adjusting pH;

b. improving shelf life stability;

c. improving wetting of the fabric;

d. maintaining solubility; and

e. improving coatability of the composition.

A fabric treated with the composition has a surface that is stain resistant and is further characterized by increased abrasion resistance and increased cut resistance. Moreover, it has been found that the longevity and durability of apparel made from the treated fabric is extended.

Fabric suitable for use in the present invention includes terry cloth made from cotton, terry cloth made from poly-paraphenylene terephthalamide or string cloth made from poly-paraphenylene terephthamide. Poly-paraphenylene terephthalamide, also known as para-aramid, is sold under the trade name KEVLAR. The poly-paraphenylene terephthalamide chains are highly oriented with strong interchain bonding which result in a unique combination of properties, including among others, superior cut resistance. The term “terry cloth” is characterized in the art as having a knitting of circular loops. The size of the loops depends on the intended use of the apparel. Other fabrics suitable for use in the present invention will become apparent to those skilled in the art in view of this disclosure.

In the exemplary embodiment, the composition is applied to the fabric by providing a roll of fabric that is continuously fed into a Tubtex machine via compression rollers. As the fabric is being fed into the machine, the fabric is directed and immersed into a bath containing the composition. A pair of compression rolls are used to remove excess from the fabric. The coating speed is optimized to insure complete wetting of the fabric and is well within the skill of those in the art. The compression rolls force the composition to penetrate into the fibers of the fabric. In an alternate embodiment, the composition is applied to the fabric with a commercial washing machine. In this embodiment, the fabric is “washed” in the commercial washing machine with the composition.

The fabric is then fed into a drying oven at a predetermined temperature that is effective to cure the composition and dry the fabric. In an alternate embodiment, the treated fabric is placed in a clothing dryer that raises the temperature of the fabric to approximately 300° F. to dry the treated fabric. The term cure as used in describing the present invention is meant to included solidifying of the composition as a result of a chemical reaction as well as solidifying of the composition as a result of evaporation and that does not involve a chemical reaction. It has been found that once the fabric is cured and dried that the treated fabric displays increased abrasion and cut resistance for up to twenty to twenty-five launderings. As the fabric is removed from the oven or dryer, it is rolled and cut according to specification as is conventional in the industry.

Alternatively, the fabric can be made into an apparel, such as a glove, in which the apparel is immersed in the solution for a period of time sufficient to saturate the apparel. Excess solution is removed from the apparel and placed in an oven or dryer to cure and dry the apparel. As the solution cures, water and acid in the solution evaporates from the solution, causing the solution to solidify on the fabric when the solution is cured.

In the case of terry cloth treated with the compositions, the cloth exhibits an extended life of at least twenty percent. The treated terry cloth is stain resistant and also displays increased abrasion resistance and cut resistance. Accordingly, apparel such as gloves made from the treated fabric will represent significant cost savings to consumers thereof.

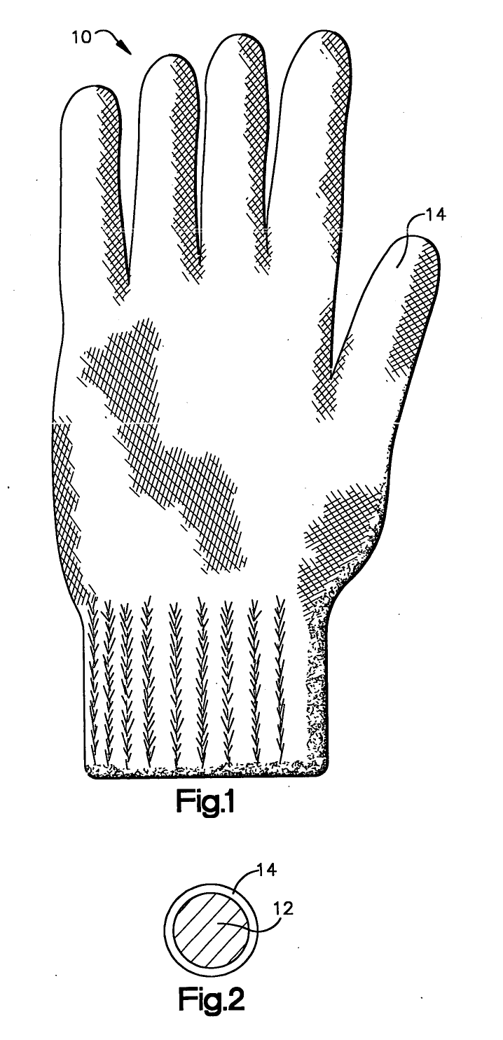

FIG. 1 illustrates a glove 10 made of a fabric (shown in FIG. 2) that has been treated with the disclosed composition. Referring to FIG. 1, a protective layer 14 of silicone softener and surfactants is formed on the fabric 14 of the glove 10, when the composition has cured. It should be noted that each fiber of the fabric need not be entirely coated.

The following examples are detailed descriptions of methods of preparation and use of the composition of the present invention. The detailed preparations fall within the scope of, and serve to exemplify, the more generally described methods set forth above. The examples are presented for illustrative purposes only, and are not intended to limit the scope of the invention.

The invention will now be described by reference to the following non-limiting examples.

### EXAMPLE 1

In this example, a composition containing the silicone softener is prepared. The following components and amounts of the composition were combined and mixed to a uniform solution. The pH of the composition was measured and determined to be between about 4.0 and about 5.5. The composition is then ready for use.

| | | |
|---|---|---|
| ULTRATEX REP | 1.65 | pounds |
| ZONYL 8787 | 1.25 | pounds |
| ALKANOL | 0.01 | pounds |
| Acetic Acid (56%) | 0.05 | pounds |
| Water | 5 | gallons |

### EXAMPLE 2

In this example, a composition containing the silicone softener is prepared. The following components and amounts of the composition were combined and mixed to a uniform solution. The pH of the composition was measured and determined to be between about 4.0 and about 5.5. The composition is then ready for use.

| | | |
|---|---|---|
| ULTRATEX REP | 2.0 | pounds |
| ZONYL 8787 | 2.5 | pounds |
| ALKANOL | 0.01 | pounds |
| Acetic Acid (56%) | 0.05 | pounds |
| Water | 5 | gallons |

### EXAMPLE 3

In this example, 100% cotton terry cloth gloves were made from fabric treated with the composition prepared according to example 1. Rolls of cotton fabric were continuously fed into a bath containing the composition and fed into a Tubtex machine. Pickup of solution by the fabric was on the order of 50 to 70%. Excess solution was removed by passing through a pair of compression rollers. The fabric was then fed into an oven at 325° F. for a time sufficient to cure and dry the fabric.

The staining resistance of the gloves manufactured from the treated fabric was measured in accordance with standard practice in the industry. A single drop of mineral oil was placed on the fabric. After about 4 minutes it was clear that the mineral oil drop did not penetrate into the fabric. Standard industry practice indicates that a fabric is stain resistance if it does not disperse or become absorbed by the fabric after 30 seconds. The results obtained show that the treated fabric is stain resistant.

### EXAMPLE 4

In this example, KEVLAR terry cloth gloves and KEVLAR string gloves were made on a Shima Seiki glove knitting machine. The gloves are knitted according to standard practices in a one piece finished form. The gloves were treated with the composition prepared in accordance with example 2. The gloves were treated by dipping the entire glove into a bath of the composition for 30 seconds. The gloves are removed from the bath and excess solution is allowed to drip back into the bath. The gloves are then passed through a continuous oven at a temperature of about 325° F. or in a clothes dryer of about 300° F. Exposure in the oven is for about ten to fifteen minutes.

The staining resistance of the gloves was tested in accordance to the process described in example 3. The results show that the treated KEVLAR glove is stain resistant.

Many modifications and variations of the invention will be apparent to those skilled in the art in light of the foregoing disclosure. Therefore, it is to be understood that, within the scope of the appended claims, the invention can be practiced otherwise than has been specifically shown and described.

What is claimed is:

1. A method of treating a fabric to increase abrasion resistance of the fabric, comprising:
a) mixing from 1 to 20% of a softener by weight with from 0.1 to 20% of a surfactant by weight and from 60 to 98.9% water by weight to form a fabric treatment mixture;
b) saturating a fabric with said fabric treatment mixture;
c) removing excess fabric treatment mixture from said fabric; and
d) drying the fabric to cure the fabric treatment mixture.

2. The method of claim 1 further comprising adding an amount of acid to said mixture that is effective to maintain the pH of the mixture between 4.0 and 5.5.

3. The method of claim 2 wherein said acid is acetic acid.

4. The method of claim 1 wherein said fabric treatment mixture is applied to said fabric with a machine that includes compression rollers that force said mixture into said fabric and remove excess mixture from the fabric.

5. The method of claim 1 wherein said fabric is a cotton terry cloth.

6. The method of claim 1 wherein said fabric is poly-paraphenylene terephthalamide.

7. The method of claim 1 wherein the fabric is terry cloth made from poly-paraphenylene terephthalamide.

8. The method of claim 1 wherein said fabric is formed into a glove before said treatment mixture is applied to said fabric.

9. The method of claim 8 wherein said glove is formed from poly-paraphenylene terephthalamide.

10. The method of claim 8 wherein said glove is formed from cotton terry.

11. The method of claim 1 further comprising forming said treated fabric into a glove.

12. The method of claim 11 wherein said fabric is formed from poly-paraphenylene terephthalamide.

13. The method of claim 8 wherein said fabric is cotton terry.

14. The method of claim 1 wherein said mixture is applied with a washing machine.

15. The method of claim 1 wherein said fabric is dried with a clothes dryer.

16. An aqueous composition for treating fabric, comprising:
a) from 1 to 20% of a softener by weight;
b) from 0.1 to 20% of a surfactant by weight; and
c) from 60 to 98.9% water by weight.

17. The composition of claim 16 further comprising an acid effective to maintain a pH of the composition in a range from 4.0 to 5.5.

18. The composition of claim 17 wherein said acid is acetic acid.

19. A method of treating a fabric to increase abrasion resistance and cut resistance of the fabric, comprising:
a) mixing from 1 to 10% of a silicone softener by weight with from 1 to 10% of a first surfactant by weight, from 0.01 to 2% of a second surfactant by weight and from 78 to 97.99 parts water by weight to form an aqueous fabric treatment mixture;
b) saturating a fabric with said fabric treatment mixture;
c) removing excess fabric treatment mixture from said fabric; and
d) drying the fabric to cure the fabric treatment mixture.

20. The method of claim 19 further comprising adding an amount of acid to said mixture that is effective to maintain the pH of the mixture between 4.0 and 5.5.

21. The method of claim 20 wherein said acid is acetic acid.

22. The method of claim 19 wherein said fabric treatment mixture is applied to said fabric with a Tubex™ machine.

23. The method of claim 19 wherein said fabric is a cotton terry cloth.

24. The method of claim 19 wherein said fabric is poly-paraphenylene terephthalamide.

25. The method of claim 19 wherein the fabric is terry cloth made from poly-paraphenylene terephthalamide.

26. The method of claim 19 wherein said fabric is formed into a glove before said treatment mixture is applied to said fabric.

27. The method of claim 26 wherein said glove is formed from poly-paraphenylene terephthalamide.

28. The method of claim 26 wherein said glove is formed from cotton terry.

29. The method of claim 19 further comprising forming said treated fabric into a glove.

30. The method of claim 29 wherein said fabric is formed from poly-paraphenylene terephthalamide.

31. The method of claim 29 wherein said fabric is cotton terry.

32. An aqueous composition for treating fabric, comprising:
a) from 1 to 10% of a silicone softener by weight;
b) from 1 to 10% of a first surfactant by weight;
c) from 0.01 to 2% of a second surfactant weight; and
d) from 78 to 97.99 parts water by weight.

33. The composition of claim 32 wherein said softener is ULTRATEX® sold by Ciba Giegy Corporation.

34. The composition of claim 32 wherein said first surfactant includes fluoropolymers.

35. The composition of claim 32 wherein said fluoropolymers are ZONYL® sold by Ciba Giegy Corporation.

36. The composition of claim 32 wherein said second surfactant is selected from the group consisting of anionic surfactant, cationic surfactant and non-ionic surfactant.

37. The composition of claim 32 wherein said second surfactant is ALKANOL® sold by Fisher Scientific.

38. A method of treating a fabric to increase abrasion resistance of the fabric, comprising:
a) mixing from 1 to 10% of a silicone softener by weight with from 1 to 10% of a first surfactant by weight, said first surfactant including fluoropolymers, with from 0.01 to 2% of a second surfactant by weight, said second surfactant is selected from the group consisting of anionic surfactant, cationic surfactant and non-ionic surfactant, with from 78 to 97.99 parts water by weight to form an aqueous fabric treatment mixture;
b) saturating a fabric with said fabric treatment mixture;
c) removing excess fabric treatment mixture from said fabric; and
d) drying the fabric to cure the fabric treatment mixture.

39. The method of claim 38 further comprising adding an amount of acid to said mixture that is effective to maintain the pH of the mixture between 4.0 and 5.5.

40. The method of claim 39 wherein said acid is acetic acid.

41. The method of claim 38 wherein said fabric treatment mixture is applied to said fabric with a Tubex™ machine.

42. The method of claim 38 wherein said fabric is a cotton terry cloth.

43. The method of claim 38 wherein said fabric is poly-paraphenylene terephthalamide.

44. The method of claim 38 wherein the fabric is terry cloth made from poly-paraphenylene terephthalamide.

45. The method of claim 38 wherein said fabric is formed into a glove before said treatment mixture is applied to said fabric.

46. The method of claim 45 wherein said glove is formed from poly-paraphenylene terephthalamide.

47. The method of claim 45 wherein said glove is formed from cotton terry.

48. The method of claim 38 further comprising the step of forming said treated fabric into a glove.

49. The method of claim 48 wherein said fabric is formed from poly-paraphenylene terephthalamide.

50. The method of claim 48 wherein said fabric is cotton terry.

51. The method of claim 38 wherein said fabric treatment mixture is applied to said fabric with a washing machine.

52. The method of claim 38 wherein said fabric is dried with a clothes dryer.

53. An aqueous composition for treating fabric, comprising:
a) from 1 to 10% of a silicone softener by weight;
b) from 1 to 10% of a first surfactant by weight, said surface active agent including fluoropolymers;
c) from 0.01 to 2% of a second surfactant by weight, said second surfactant is selected from the group consisting of anionic surfactant, cationic surfactant and non-ionic surfactant; and
d) from 78 to 97.99 parts water by weight.

54. A method of making a cut-resistant glove, comprising:
a) mixing ULTRATEX® REP, ZONYL® 8787, ALKANOL®, Acetic Acid (56%) and water in a ratio of 1.65 pounds ULTRATEX® REP, 1.25 pounds ZONYL® 8787, 0.01 pounds ALKANOL®, 0.05 pounds Acetic Acid (56%), and 5 gallons water to form a fabric treatment mixture;
b) saturating a cotton terry fabric with said fabric treatment mixture;
c) removing excess fabric treatment mixture from said fabric;
d) drying the fabric to cure the fabric treatment mixture; and
e) forming said cotton terry fabric into a glove.

55. The method of claim 54 wherein said cotton terry fabric is formed into a glove before being saturated with said fabric treatment mixture

56. An aqueous composition for treating fabric used in making cut and abrasion resistant gloves, comprising:
a mixture of ULTRATEX® REP, ZONYL® 8787, ALKANOL®, Acetic Acid (56%) and water in a ratio of 1.65 pounds ULTRATEX® REP, 1.25 pounds ZONYL® 8787, 0.01 pounds ALKANOL®, 0.05 pounds Acetic Acid (56%), and 5 gallons of water to form a fabric treatment mixture.

57. A method of making a cut-resistant glove, comprising:
a) mixing ULTRATEX® REP, ZONYL® 8787, ALKANOL®, Acetic Acid (56%) and water in a ratio of 2.0 pounds ULTRATEX® REP, 2.5 pounds ZONYL® 8787, 0.01 pounds ALKANOL®, 0.05 pounds Acetic Acid (56%), and 5 gallons water to form a fabric treatment mixture;
b) saturating a KEVLAR® glove with said fabric treatment mixture;
c) removing excess fabric treatment mixture from said glove;
d) drying the fabric to cure the fabric treatment mixture.

58. An aqueous composition for treating fabric used in making cut and abrasion resistant gloves, comprising:
a mixture of ULTRATEX® REP, ZONYL® 8787, ALKANOL®, Acetic Acid (56%) and water in a ratio of 2.0 pounds ULTRATEX® REP, 2.5 pounds ZONYL® 8787, 0.01 pounds ALKANOL®, 0.05 pounds Acetic Acid (56%), and 5 gallons water to form a fabric treatment mixture.

59. A cut and abrasion resistant glove, comprising:
a) a cotton terry fabric formed into the shape of a glove; and
b) a cut resistant coating on said cotton terry fabric, said coating including a silicone softener, a first surfactant that includes fluoropolymers, and a second surfactant.

60. A cut and abrasion resistant glove, comprising:
a) a poly-paraphenylene terephthalamide fabric formed into the shape of a glove; and
b) a cut resistant coating on said fabric, said coating including a silicone softener, a first surfactant that includes fluoropolymers, and a second surfactant.
b) mixing from 1 to 20% of a softener by weight with from 0.1 to 20% of a surfactant by weight and from 60 to 98.9% water by weight to form a fabric treatment mixture;
b) saturating said glove with said fabric treatment mixture;
c) removing excess fabric treatment mixture from said glove; and
d) drying the glove to cure the fabric treatment mixture.

62. The method of claim 61 wherein said fabric is a cotton terry fabric.

63. The method of claim 61 wherein said fabric is a poly-paraphenylene terephthalamide fabric.
